(19) United States
(12) Patent Application Publication
(10) Pub. No.: US 2017/0255079 A1
(43) Pub. Date: Sep. 7, 2017

(54) TUNABLE OPTICAL DIRECTIONAL COUPLER

(71) Applicants: Jia Jiang, Ottawa (CA); Chunshu Zhang, Kanata (CA)

(72) Inventors: Jia Jiang, Ottawa (CA); Chunshu Zhang, Kanata (CA)

(21) Appl. No.: 15/058,761

(22) Filed: Mar. 2, 2016

(51) Int. Cl. G02F 1/313

(52) U.S. Cl. CPC G02F 1/3133; G02F 1/3138; G02F 1/3136; G02F 2202/10

(57) ABSTRACT

A tunable optical directional coupler includes a first waveguide and a second waveguide proximal to the first waveguide, the first and second waveguides defining a light-coupling coefficient. The tunable optical directional coupler also includes a doped junction having a refractive index that is responsive to an applied bias voltage wherein the refractive index is changeable to enable tuning of the light-coupling coefficient. The tunable optical directional coupler may be used to split power, tune the phase, split polarizations or to tune a ratio of a tap-monitor.

### TECHNICAL FIELD

The present disclosure relates generally to optical telecommunications and, more particularly, to optical directional couplers.

### BACKGROUND

Optical directional couplers are commonly used in photonic integrated circuits. In a directional coupler, two optical waveguides are placed in proximity to each other such that the evanescent field of the first waveguide overlaps the second waveguide, resulting in a gradual coupling of light between the waveguides. The coupling coefficient is affected by the waveguide gap, the light interaction length and waveguide width.

Tunable optical directional couplers are used for applications such as power splitters, tap-monitors, polarization splitters and optical switches.

Tunable optical directional couplers are conventionally implemented using a thermo-optic effect. Applying heat causes the refractive index to change, thereby modifying the coupling coefficient. The thermo-optic effect is relatively slow, however, enabling typical response times in the millisecond range or slower. A more rapid tunable optical directional coupler would be highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses a tunable optical directional coupler having a doped junction, e.g. a PIN or PN junction, that has a refractive index that changes as a function of applied bias voltage. A coupling coefficient between the first and second optical waveguides can be tuned by adjusting the bias voltage.

One inventive aspect of the disclosure is a tunable optical directional coupler having a first waveguide, a second waveguide proximal to the first waveguide, the first and second waveguides defining a light-coupling region therebetween, the light-coupling region having a light-coupling coefficient and a doped junction at least partially overlapping the light-coupling region and having a refractive index that is responsive to an applied bias voltage wherein the refractive index is changeable to enable tuning of the light-coupling coefficient of the light-coupling region.

Another inventive aspect of the disclosure is a method of tuning a tunable optical directional coupler. The method entails transmitting light through a first waveguide, coupling a portion of the light from the first waveguide to a second waveguide proximal to the first waveguide and defining a light-coupling region therebetween, the light-coupling region having a light-coupling coefficient, and applying a bias voltage to a doped junction at least partially overlapping the light-coupling region and having a refractive index that is responsive to the applied bias voltage to thereby tune the light-coupling coefficient.

### BRIEF DESCRIPTION OF THE DRAWINGS

These and other features of the disclosure will become more apparent from the description in which reference is made to the following appended drawings.

FIG. 1 depicts a directional coupler having a symmetrically doped PIN junction.

FIG. 2 depicts a portion of the directional coupler of FIG. 1 for illustration of fine tuning of a splitting ratio.

FIG. 3 depicts a directional coupler having an asymmetrically doped PIN junction.

FIG. 4 depicts a portion of the directional coupler of FIG. 3 for illustration of coarse tuning of a splitting ratio.

FIG. 5 depicts a directional coupler having a transversal PN junction.

FIG. 6 depicts a directional coupler having a reduced wavelength sensitivity.

FIG. 7 is a graph plotting the refractive index as a function of length along the waveguides of the directional coupler of FIG. 5.

FIG. 8 depicts a Mach-Zehnder interferometer including a pair of tunable optical directional couplers having tunable input and output phase balance for tuning optical power coupling ratio of the directional couplers.

FIG. 9 depicts the tunable optical directional coupler being used for tuning a ratio of a tap-monitor.

FIG. 10 depicts an optical directional coupler being used for polarization splitting.

FIG. 11 depicts a tunable optical directional coupler being used for optical switching in which the directional coupler has an asymmetrical junction.

FIG. 12 is a graph plotting the optical power as a function of distance, showing the coupling of optical power from a first waveguide to a second waveguide for different changes in refractive index.

FIG. 13 is a flowchart presenting a method of manufacturing a tunable optical directional coupler.

FIG. 14 is a flowchart presenting a method of tuning a tunable optical directional coupler.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

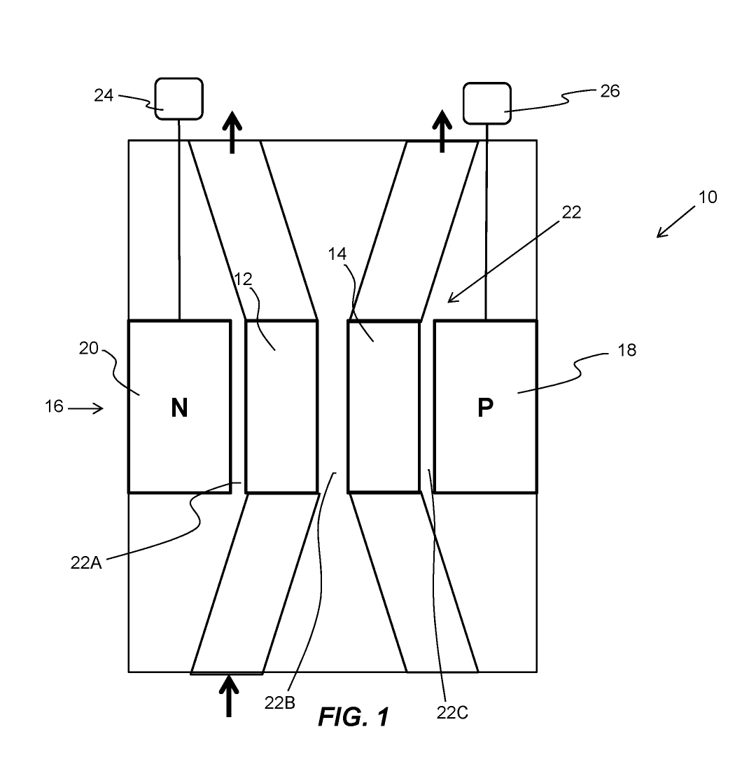

In the embodiment depicted by way of example in FIG. 1, a tunable optical directional coupler 10 includes a first waveguide 12 and a second waveguide 14 that is proximal to the first waveguide 12 such that light couples evanescently from the first waveguide 12 to the second waveguide 14. Evanescent coupling between two optical waveguides arises when the two waveguides are placed close together so that the evanescent field generated by the first waveguide 12 excites a wave in the second waveguide 14. The first and second waveguides 12, 14 define a light-coupling region therebetween, i.e. in the space or gap between the first and second waveguides 12, 14. The light-coupling region has a light-coupling coefficient.

The first and second waveguides 12, 14 are shown to be parallel in this figure although in other embodiments the first and second waveguides 12, 14 are not parallel. The first and second waveguides 12, 14 are shown to be equally wide in this figure although in other embodiments the first and second waveguides 12, 14 may have different widths. The directional coupler 10 includes a doped semiconductor junction 16. The doped junction 16 at least partially overlaps the light-coupling region and has a refractive index that is responsive to an applied bias voltage. The refractive index is changeable to enable tuning of the light-coupling coefficient of the light-coupling region. In this particular embodiment, the doped junction 16 is a symmetrically doped PIN junction. The symmetrically doped PIN junction 16 includes a p-type region 18, an n-type region 20 and an intrinsic region 22. In this embodiment, the intrinsic region 22 overlaps the first and second waveguides 12, 14. In this embodiment, as shown in the plan view of FIG. 1, there is a first lateral strip 22A of the intrinsic region between the n-type region 20 and the first waveguide 12, a middle strip 22B of the intrinsic region between the first waveguide 12 and the second waveguide 14, and a second lateral strip 22C of the intrinsic region between the second waveguide 14 and the p-type region 18. The first 22A and second 22C narrow strips of the intrinsic region 22 are of equal width in this illustrated embodiment although in other embodiments the widths may be unequal. In another embodiment, the middle strip 22B may be of the same width or narrower than the lateral strips 22A, 22C. Dopant ions such as boron and phosphorus, or any other functionally equivalent ions, may be implanted to form the doped PIN junction 16. Forward or reversed bias-induced free carrier injection or depletion of the doped PIN junction 16 provides the controllable variability in the refractive index and absorption, thereby making the directional coupler tunable. In other words, the refractive index is responsive to changes in the applied bias voltage. By varying the bias voltage, the coupling coefficient (K) may be varied.

The change in refractive index, Δn, of silicon material as a function of the concentration of free carriers is given by the following equation: Δn=−[8.8×10⁻²²ΔNₑ+8.5×10⁻¹⁸(ΔNₕ)^{0.8}] where ΔNₑ represents the change in electron concentration and ΔNₕ, represents the change in hole concentration.

The change in absorption of the silicon material as a function of the concentration of free carriers is given by the following equation: Δα=8.5×10⁻¹⁸ΔNₑ+6.0×10⁻¹⁸ΔNₕ

In one embodiment, the ion concentration may range from 10¹⁵ to 10²⁰/cm³ depending on the junction design and the requirements of the tuning ratio and waveguide loss.

In the embodiment depicted by way of example in FIG. 1, the doped junction 16 is electrically biased by applying a bias voltage to the doped junction 16. The bias voltage is applied to the doped junction 16 using first and second electrodes 24, 26 in this embodiment. The first electrode 24 (having a voltage V_{ref}) is electrically connected to the n-type region 20. The second electrode 26 (having a voltage V_{ref}+V_{DC}) is electrically connected to the p-type region 18. The doped junction 16 is thus forward biased.

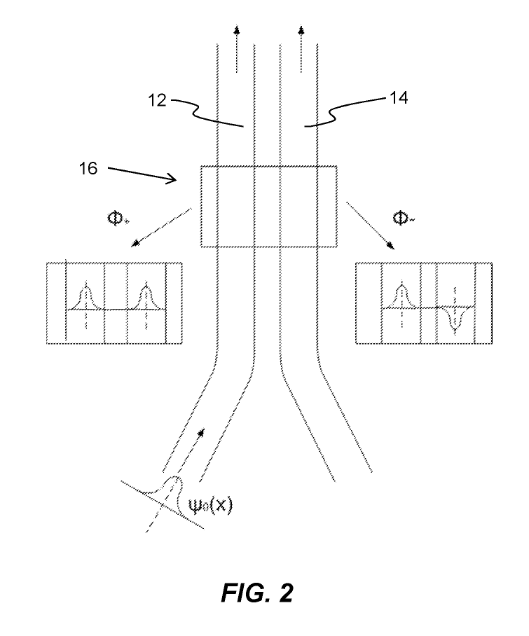

FIG. 2 presents a method of finely tuning a splitting ratio using the directional coupler 10 of FIG. 1 for first and second waveguides 12, 14 of equal width. The doped junction 16 in this embodiment generates two supermodes, namely a symmetric mode (φ+) and an antisymmetric mode (φ−).

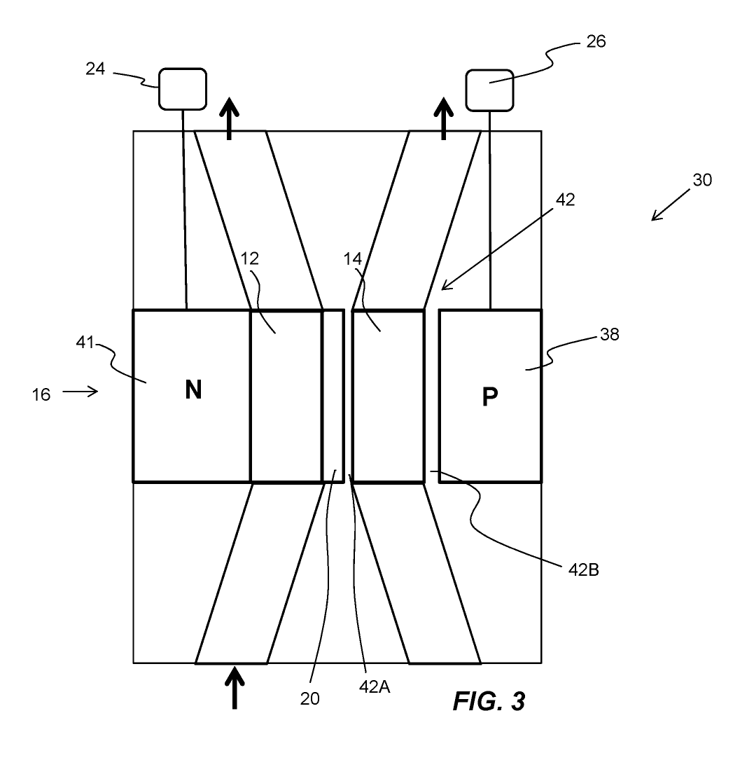

FIG. 3 depicts a directional coupler 30 having an asymmetrically doped PIN junction 36 in accordance with another embodiment. In the embodiment shown by way of example in FIG. 3, the first waveguide 12 and the second waveguide 14 are sufficiently proximal such that light couples evanescently from the first waveguide 12 to the second waveguide 14. In this particular embodiment, the doped PIN junction 36 is an asymmetrically doped PIN junction. The asymmetrically doped PIN junction 36 includes a narrower p-type region 38, a wider n-type region 41 overlapping the first waveguide 12 and an intrinsic region 42 overlapping the second waveguide 14. The p-type and n-type regions 38, 41 could be reversed, i.e. the p-type region 38 could be wider than the n-type region 41 in another embodiment. In the illustrated embodiment, the intrinsic region 42 includes a narrow left strip 42A between the n-type region 41 and the second waveguide 14. The intrinsic region 42 also includes a wider right strip 42B between the second waveguide 14 and the p-type region 38. The left 42A and right 42B strips of the intrinsic region 42 in this embodiment are of unequal width although in other embodiments the widths may be equal.

In the embodiment depicted by way of example in FIG. 3, the doped junction 16 is electrically biased by applying a bias voltage to the doped junction 16. The bias voltage is applied to the doped junction 16 using the first and second electrodes 24, 26 in this embodiment. The first electrode 24 (having a voltage V_{ref}) is electrically connected to the n-type region 20. The second electrode 26 (having a voltage V_{ref}+V_{DC}) is electrically connected to the p-type region 18. The doped junction 16 is thus forwardly biased.

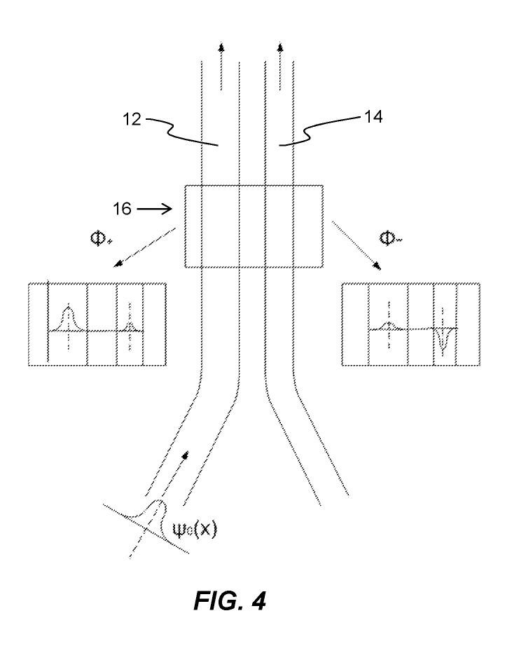

FIG. 4 presents a method of coarsely tuning a splitting ratio using the directional coupler 30 of FIG. 3. This asymmetric coupler generates modes that are not perfectly symmetric and antisymmetric.

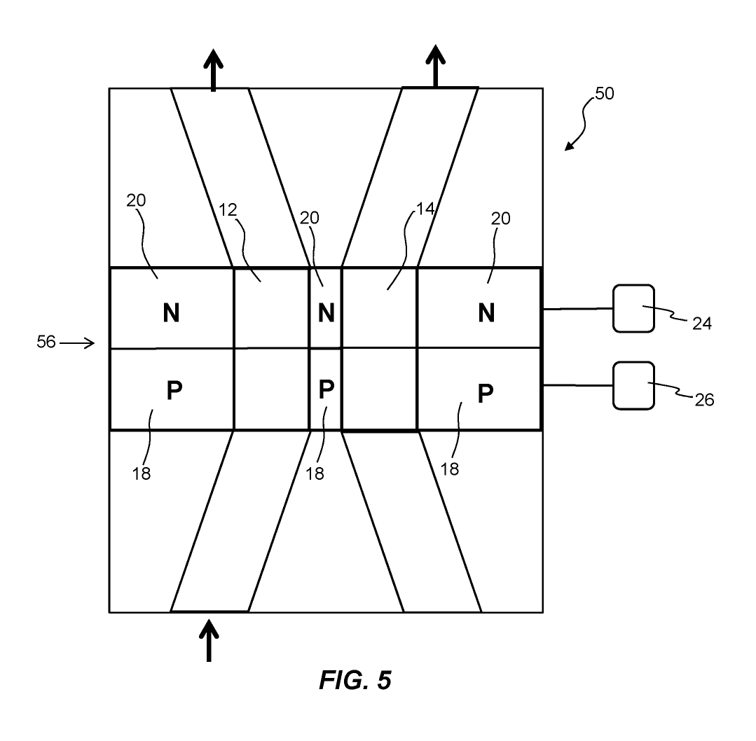

FIG. 5 depicts a directional coupler 50 having a transversal PN junction 56 in accordance with another embodiment. In this embodiment, the doped junction is a PN junction instead of a PIN junction. Similarly to the directional coupler 10 of FIG. 1, the directional coupler 50 of FIG. 5 has the first waveguide 12 and the second waveguide 14. The PN junction 56 has the p-type region 18 and the n-type region 20, which are however transversely disposed with respect to the first 12 and second 14 waveguides. The n-type region 20 overlaps a downstream portion of the first and second waveguides 12, 14, i.e. there is an n-type region in between and on both sides of the first and second waveguides 12, 14. Likewise, the p-type region 18 overlaps an upstream portion of the first and second waveguides 12, 14, i.e. there is a p-type region in between and on both sides of the first and second waveguides 12, 14. In one embodiment, the p-type region 18 and/or the n-type region 20 may have an ion concentration gradient.

In the embodiment depicted by way of example in FIG. 5, the PN junction 56 is electrically biased by applying a bias voltage to the PN junction 56. The bias voltage is applied to the PN junction 56 using first and second electrodes 24, 26 in this embodiment. The first electrode 24 (having a voltage V_{ref}) is electrically connected to the n-type region 20. The second electrode 26 (having a voltage V_{ref}−V_{DC}) is electrically connected to the p-type region 18. The PN junction 56 is reverse biased.

The tunable optical directional couplers 10, 30, 50 may be particularly well suited for fast photonic circuits because they provide much faster response times than comparable thermo-optically tunable directional couplers. It will be appreciated that the geometry and ion concentration of the doped junctions can be designed to meet specific requirements.

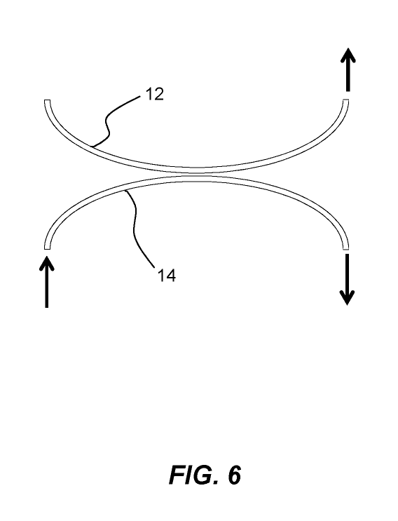

The directional coupler 50 of FIG. 5 can function as a wavelength-insensitive directional coupler of the type shown in FIG. 6. In FIG. 6, the gradually changing waveguide gap produces an effective index change that lessens effects of the change in the coupling ratio that arises due to the waveguide material dispersion. Similarly, the applied bias on the PN junction creates the gradually changing effective index along the waveguide in FIG. 5, which operates based on the same principle as described above with respect to FIG. 6. Using this principle, a coupler having an equal coupling ratio can be designed for a broad band of wavelengths.

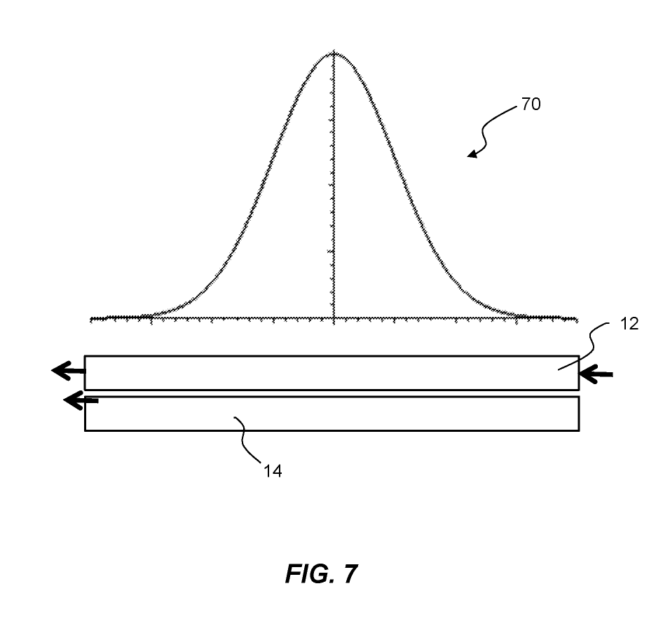

FIG. 7 is a graph denoted 70 plotting the refractive index as a function of length along the first and second waveguides 12, 14 in the directional coupler 50 of FIG. 5 by applied voltage bias. The index varies approximately parabolically as shown in the graph, which is used to design a directional coupler with reduced wavelength sensitivity, such as depicted in FIG. 6.

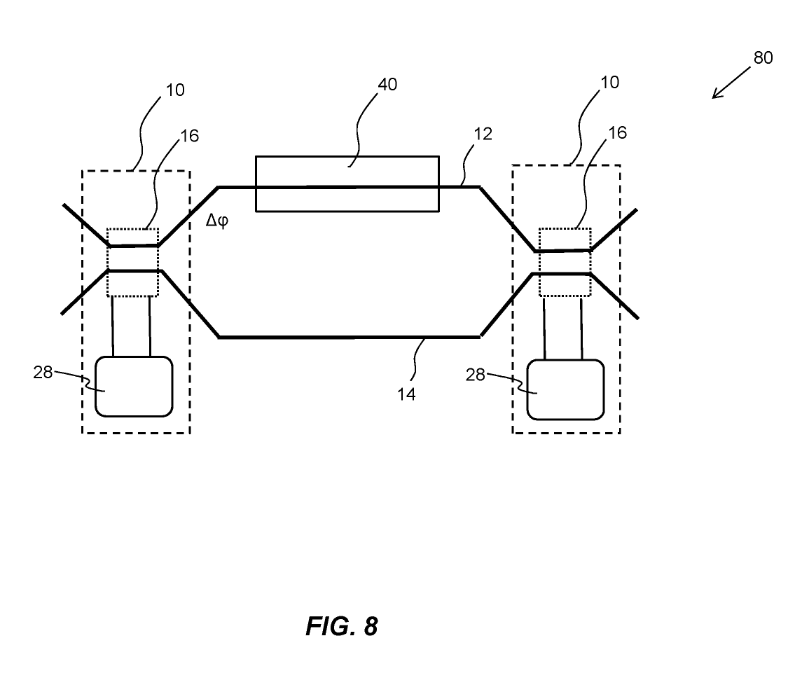

FIG. 8 depicts the tunable optical directional coupler 10 being used to tune a coupling ratio to reduce an optical power imbalance between two output arms of a Mach-Zehnder interferometer 80. In the bidirectional system shown in FIG. 8, there are two tunable optical directional couplers 10, each having a doped junction (by way of example, either the PIN junction 16 or the PN junction 56; the PIN junction 16 is shown) for changing a coupling coefficient between the first and second waveguides 12, 14 by varying the refractive index of the PIN junction 16. A bias voltage source 28 applies the bias voltage via electrodes to the doped junction 16 in each directional coupler 10. The system of FIG. 8 includes a phase shifter 40 on one of the two waveguides 12, 14 to tune a phase delay, or optical path difference, between the first 12 and second 14 waveguides. This system can be used for coupling ratio compensation for a Mach-Zehnder Interferometer (MZI) switch to realize higher extinction ratios.

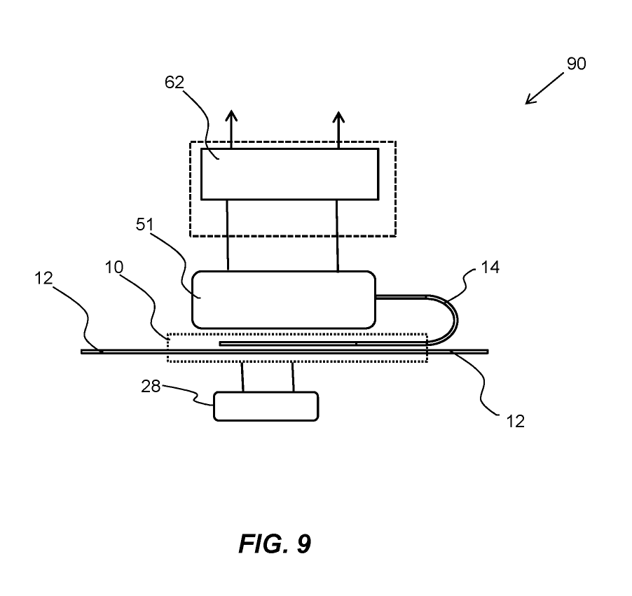

FIG. 9 depicts the tunable optical directional coupler 10 being used for tuning a power splitting ratio of a tap-monitor 90. The tap-monitor 90 includes an electrical circuit board 62 that outputs control signals to control an external device or apparatus (not shown in the figure). The tunable optical directional coupler 10 tunes the coupling coefficient between the first waveguide 12 and the second waveguide 14 by applying a bias voltage from a bias voltage source 28. The light coupled into the second waveguide 14 is detected by a photodetector 51. The photodetector 51 generates signals that are received and processed by the electrical circuit board 62 of the tap-monitor.

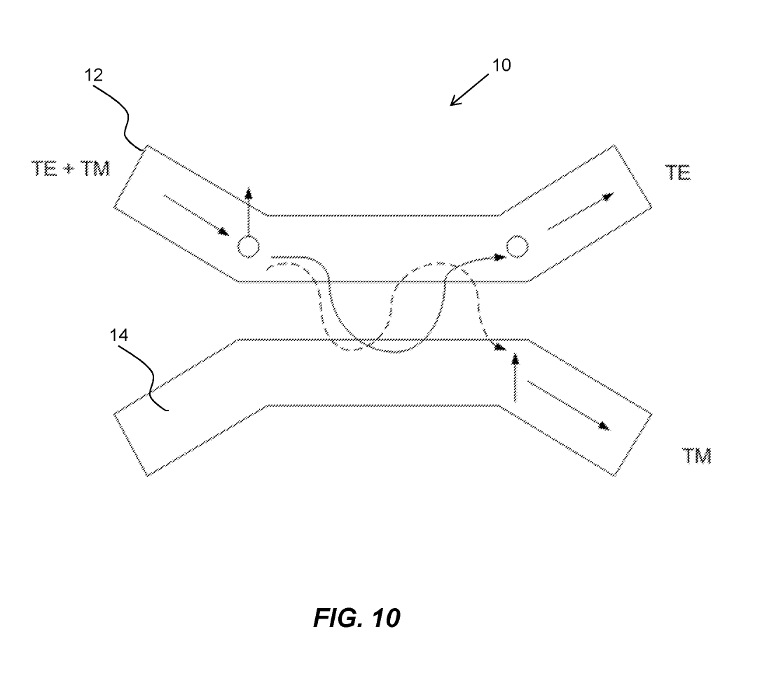

FIG. 10 depicts the optical directional coupler 10 being used for polarization splitting. Light having both transverse electric (TE) and traverse magnetic (TM) polarization components are carried on the first waveguide 12. As the refractive index is typically different between the TE and TM polarizations, different coupling lengths can be used for splitting the TE and TM modes. The directional coupler in FIG. 10, whose coupling length is designed for TM, couples the TM polarization component onto the second waveguide 14, leaving only the TE component on the first waveguide 12.

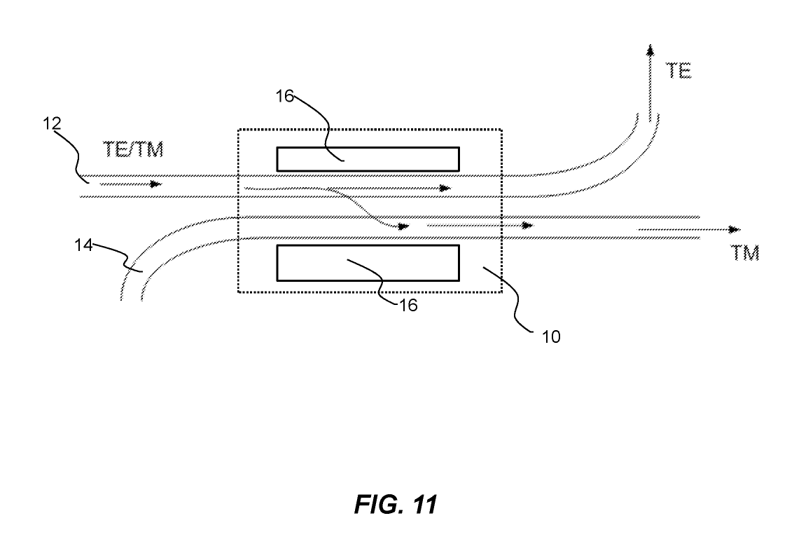

FIG. 11 depicts the tunable optical directional coupler 10 being used for polarization splitting in which the directional coupler 10 has a symmetrically doped junction or an asymmetrical doped junction 16. The doped junction 16 induces a refractive index change by electrical bias, and then splits the TE and TM components, or changes the splitting ratio between the bar port and cross port, respectively. The bar port is, in this example, the first waveguide 12 carrying the incoming light whereas the cross port in this example is the second waveguide 14 into which the TM component is coupled. In the couplers shown in FIGS. 8 to 11, the directional couplers 30 of FIGS. 3 and 50 of FIG. 5 may also be used instead of, or in addition to, the directional coupler 10 of FIG. 1.

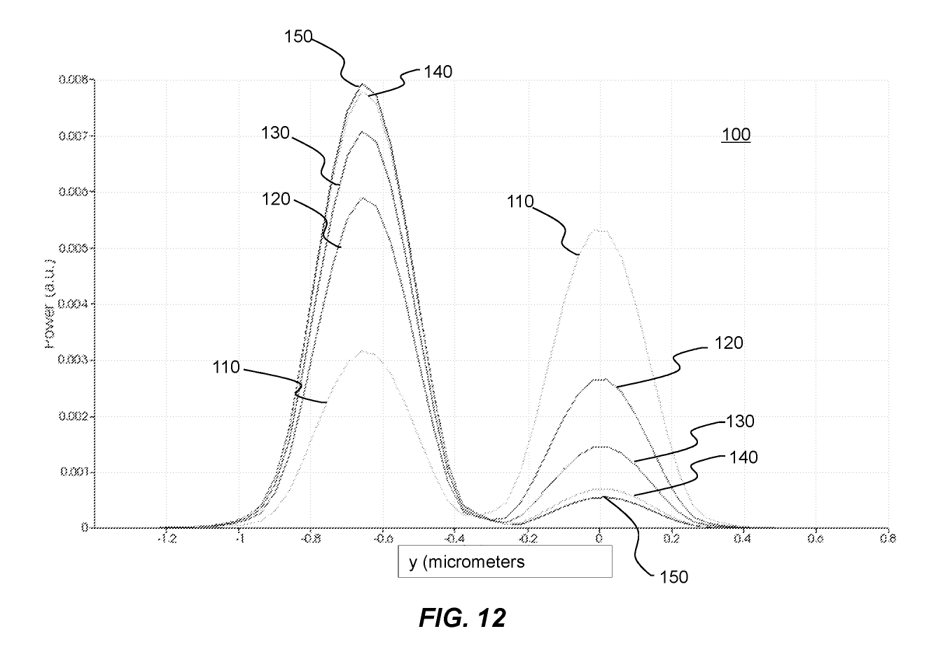

FIG. 12 is a graph denoted by reference numeral 100 plotting (for different changes in refractive index) the optical power as a function of distance in micrometers, showing the output power in both waveguides, in which the optical power is coupling from a first waveguide to a second waveguide for different values of An (change in refractive index) induced by electrical biased-PIN or PN junctions. Plot 150 represents the power distribution for Δn=0, which means that no electrical bias is being applied to the PIN junction. The design coupling ratio in the example is 90/10. Plot 140 represents the power distribution for Δn=0.0001. Plot 130 represents the power distribution for Δn=0.001. Plot 120 represents the power distribution for Δn=0.005. Plot 110 represents the power distribution for Δn=0.01. The graph shows that the coupling ratio changes gradually to about 25/75 at Δn=0.01.

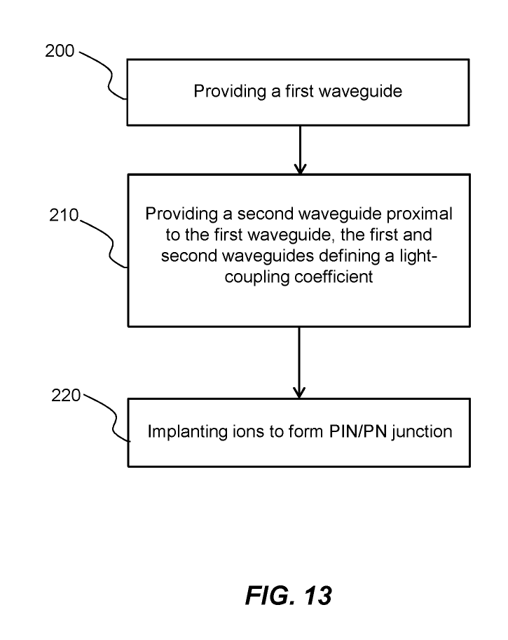

Another inventive aspect of the present disclosure is a method of manufacturing a tunable optical directional coupler. As shown in FIG. 13, the method of manufacturing (or making) the tunable optical directional coupler entails providing (200) a first waveguide, providing (210) a second waveguide proximal to the first waveguide, the first and second waveguides defining a light-coupling coefficient, and implanting ions to form p-type and n-type regions that define a doped PIN or PN junction. The PIN or PN junction may be formed in an ion implantation step (doping step) implanting ions of boron and/or phosphorus. Functionally equivalent ions may be substituted to produce the doped PIN or PN junction.

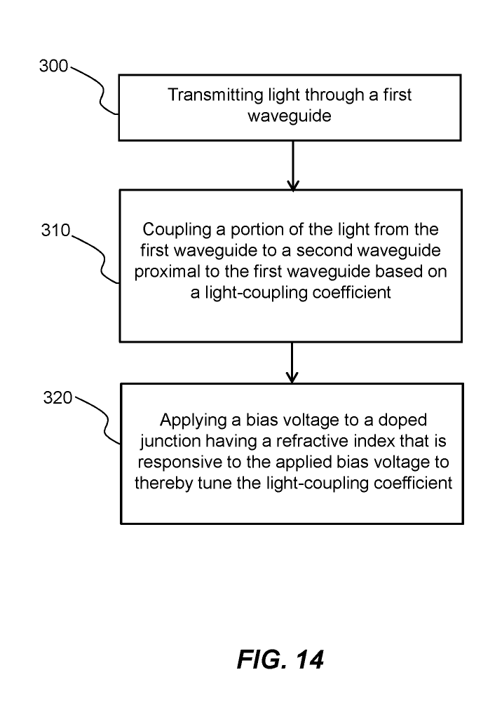

Yet another inventive aspect of the present disclosure is a method of tuning a tunable optical directional coupler. As shown in FIG. 14, the method of tuning the tunable optical directional coupler entails transmitting (300) light through a first waveguide, coupling (310) a portion of the light from the first waveguide to a second waveguide proximal to the first waveguide based on a light-coupling coefficient coupling, and applying (220) a bias voltage to a doped junction having a refractive index that is responsive to the applied bias voltage to thereby tune the light-coupling coefficient. In one implementation, the bias voltage is applied to a PIN junction which may be either a symmetrically doped PIN junction or an asymmetrically doped PIN junction, as described above. In another implementation, the bias voltage is applied to a PN junction. The PIN or PN junction may be formed in a previous doping step, as described above, by ion implantation of boron and/or phosphorus. Functionally equivalent ions may be substituted to produce the doped PIN or PN junction.

The method has a variety of useful applications. For example, the method may be used to tune a power splitting ratio, tune a tap ratio of a tap-monitor, or split TE and TM polarizations.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. A tunable optical directional coupler comprising:
a first waveguide;
a second waveguide proximal to the first waveguide, the first and second waveguides defining a light-coupling region therebetween, the light-coupling region having a light-coupling coefficient; and
a doped junction at least partially overlapping the light-coupling region and having a refractive index that is responsive to an applied bias voltage wherein the refractive index is changeable to enable tuning of the light-coupling coefficient of the light-coupling region.

2. The directional coupler of claim 1 wherein the doped junction is a PIN junction.

3. The directional coupler of claim 1 wherein the doped junction is a PN junction.

4. The directional coupler of claim 2 wherein the PIN junction is symmetrically doped with respect to the light-coupling region.

5. The directional coupler of claim 2 wherein the PIN junction is asymmetrically doped with respect to the light-coupling region.

6. The directional coupler of claim 1 wherein the doped junction is disposed along one or both of the first and second waveguides.

7. The directional coupler of claim 1 wherein the doped junction overlaps one or both of the first and second waveguides.

8. The directional coupler of claim 1 wherein the doped junction comprises a ion concentration gradient.

9. The directional coupler of claim 1 wherein the doped junction comprises phosphorus or boron.

10. The directional coupler of claim 1 wherein the doped junction is transversely disposed with respect to the first and second waveguides.

11. A method of tuning a tunable optical directional coupler, the method comprising:
transmitting light through a first waveguide;
coupling a portion of the light from the first waveguide to a second waveguide proximal to the first waveguide and defining a light-coupling region therebetween, the light-coupling region having a light-coupling coefficient; and
applying a bias voltage to a doped junction at least partially overlapping the light-coupling region and having a refractive index that is responsive to the applied bias voltage to thereby tune the light-coupling coefficient.

12. The method of claim 11 wherein the applying of the bias voltage is to a PIN junction.

13. The method of claim 11 wherein the applying of the bias voltage is to a PN junction.

14. The method of claim 12 wherein the applying of the bias voltage is to a symmetrically doped PIN junction.

15. The method of claim 12 wherein the applying of the bias voltage is to an asymmetrically doped PIN junction.

16. The method of claim 11 wherein the doped junction is formed by ion implantation of boron or phosphorus.

18. The method of claim 11 wherein the applying of the bias voltage tunes a power splitting ratio of the tunable optical directional coupler.

19. The method of claim 11 wherein the applying of the bias voltage tunes a tap ratio of a tap-monitor.

20. The method of claim 11 wherein the applying of the bias voltage splits TE and TM polarizations.
